(19) United States
(12) Patent Application Publication
(10) Pub. No.: US 2025/0230809 A1
(43) Pub. Date: Jul. 17, 2025

(54) PUMP PERFORMANCE DATA LOGGING APPARATUS

(71) Applicant: KIMLEY-HORN TECHNOLOGY SOLUTIONS, INC., Raleigh, NC (US)

(72) Inventor: Zak PURVIS, Cary, NC (US)

(21) Appl. No.: 19/098,471

(22) Filed: Apr. 2, 2025

Related U.S. Application Data
(63) Continuation of application No. 17/484,133, filed on Sep. 24, 2021.
(60) Provisional application No. 63/084,087, filed on Sep. 28, 2020.

(51) Int. Cl. F04B 49/06; F04B 51/00; G06F 11/30; G06F 15/00; G08B 1/08

(52) U.S. Cl. CPC F04B 49/065; F04B 51/00; G06F 11/30; G06F 15/00; G08B 1/08

(57) ABSTRACT

A pump performance data logging system is provided. The pump performance data logging system comprises a pump and a plurality of sensors configured to measure at least two different parameters regarding the operation or condition of the pump. The pump performance data logging system also comprises a data logging apparatus having processing circuitry, memory, a case, and a plurality of sensors ports that are configured to receive the plurality of sensors. The case is configured to encase the plurality of sensor ports, the memory, and the processing circuitry, and the data logging apparatus weighs 50 pounds or less.

### RELATED APPLICATIONS

This application is a continuation of U.S. application Ser. No. 17/484,133, filed Sep. 24, 2021, which claims the benefit of U.S. Provisional Application Ser. No. 63/084,087, filed on Sep. 28, 2020. Each of these applications are herein incorporated by reference in their entirety for all purposes.

### FIELD OF THE INVENTION

Embodiments of the present invention relate generally to a pump performance data logging apparatus.

### BACKGROUND OF THE INVENTION

Other pump test devices that are currently available provide a limited amount of functionality and portability. For example, these test devices commonly possess only a limited number of sensors, limiting the number of properties that may be evaluated at any given time. Separate devices may sometimes be used to obtain data on various metrics, but the use of separate devices can be difficult for users to manage for multiple reasons. Users may have difficulty transporting separate devices. Additionally, using multiple devices to obtain data may be difficult as it may require users to view data from multiple devices simultaneously. This may hamper a user's ability to quickly synthesize and assess the presented information.

Existing devices are also difficult to operate for users, limiting the user's ability to make important assessments and changes in real-time. Many devices allow little input from the users and instead provide one-way communication of data for the user to view. This may limit the ability of the user to optimize the devices so that the devices may operate with greater accuracy. Additionally, the existing devices frequently display only limited information to users. Devices may display raw data for users to view with only a limited amount of performance data displayed.

### SUMMARY OF THE INVENTION

Certain embodiments of the present invention relate to a data logging apparatus with multiple sensors. While some embodiments of the data logging apparatus are specifically designed for testing water and wastewater pumps, the embodiments may be utilized for different pumps in various settings. In a preferred embodiment, the data logging apparatus may be implemented within a single unit that may be carried by a single person, which makes the data logging apparatus easily transportable. Embodiments of the data logging apparatus may be set up on a site, collect data on one or more pumps, and then be removed from the site.

Some embodiments of the data logging apparatus possess an improved interface and improved software that allow users to quickly navigate to find relevant information. The data logging apparatus may receive data from sensors, analyze that data, and display that data to users in a tabular or graphical format. Information may be presented on a display on the data logging apparatus or a display on a connected tablet. Additionally, the data logging apparatus's improved user interface and software allows users to easily input relevant information into the data logging apparatus to organize the data or to enable the data logging apparatus to perform calculations. The data logging apparatus may be configured to allow two-way communication—for example, the data logging apparatus may receive an input from a user, and the processing circuitry within the data logging apparatus may be configured to adjust the operation of the data logging apparatus based on the received input. The data logging apparatus may be configured to calculate a performance metric based on the received input and present the performance metric to the user.

In several embodiments, the data logging apparatus may also allow users to quickly check the voltage, amperage, and various other electrical parameters of a device without removing an external interface panel. These embodiments may include voltmeter volt tips that are available on an external interface panel. By including this feature on the external interface panel, users may save time in authenticating the voltage measurements or other measurements produced by the data logging apparatus.

The data logging apparatus allows users to evaluate a wide array of measurements regarding the performance of a device. Notably, the data logging apparatus may comprise specialized dedicated processing circuitry for measuring electrical frequency and electrical harmonics, which is a significant improvement over prior devices as it allows users to evaluate critical information such as the electrical frequency, phase, phase shift values, etc. Example specialized dedicated processing circuitry that may be used is a Microchip ATM90E36A processor, but other processors or similar devices may be used. The use of dedicated processing circuitry may permit more frequent and more accurate measurements for frequency and harmonics. The data logging apparatus also provides an increased number of ports where various sensors may be connected, and these ports are compatible with a wide array of sensors.

Further areas of applicability of the present invention will become apparent from the detailed description provided hereinafter. It should be understood that the detailed description and specific examples, while indicating the preferred embodiments of the invention, are intended for purposes of illustration only and are not intended to limit the scope of the invention.

### BRIEF DESCRIPTION OF THE DRAWINGS

The present invention will become more fully understood from the detailed description and the accompanying drawings, which are not necessarily to scale, wherein:

FIG. 1 is a schematic diagram of a pump and an embodiment of a data logging apparatus.

FIG. 2 is a schematic diagram of various sensors within an embodiment of the data logging apparatus.

FIG. 3 is a perspective view of an embodiment of the data logging apparatus.

FIG. 4 is a schematic diagram of example system architecture within an embodiment of the data logging apparatus.

FIG. 5 is a schematic diagram showing an example system control PCB block diagram within an embodiment of the data logging apparatus.

FIG. 6 is a view of an example data collection header that may be included within one or more views on a display.

FIG. 7 is an example scrolling data view that may be presented to users within one or more views on a display.

FIG. 8 is an example scrolling data view that may be presented to users within one or more views on a display.

FIG. 9 is an example tabular view that may be presented to users within one or more views on a display.

FIG. 10A is an example graphical view that may be presented to users within one or more views on a display.

FIG. 10B is another example graphical view that may be presented to users within one or more views on a display.

FIG. 11 is a view of an example graphical results screen that may be presented to users on a display.

FIG. 12 is a view of an example tabular results screen that may be presented to users on a display.

FIG. 13 is a view of an example site configuration screen that may be presented to users on a display.

FIG. 14 is a view of an example meter data screen that may be presented to users on a display.

FIG. 15 is a view of an example power meter data screen that may be presented to users on a display.

FIG. 16 is a view of an example system configuration screen that may be presented to users on a display.

### DESCRIPTION OF THE PREFERRED EMBODIMENTS

The following description of the embodiments of the present invention is merely exemplary in nature and is in no way intended to limit the invention, its application, or uses. The following description is provided herein solely by way of example for purposes of providing an enabling disclosure of the invention but does not limit the scope or substance of the invention.

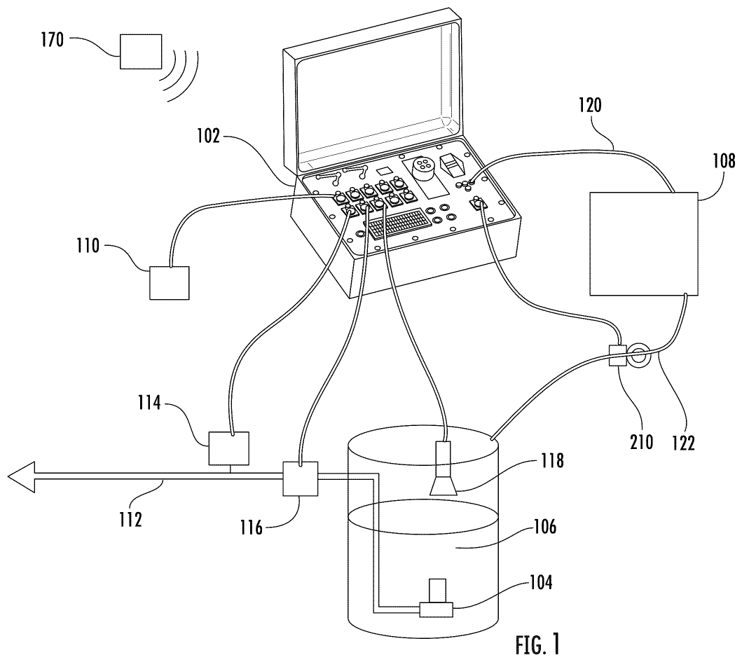

FIG. 1 is a schematic view of an embodiment of a data logging apparatus 102 alongside a pump 104. In FIG. 1, the pump 104 is disposed within a wet well 106. However, the pump 104 may be disposed in other environments, including, for example, a ground storage. The data logging apparatus 102 may be utilized with a wide variety of pumps. The data logging apparatus 102 may be used with pumps in different settings, but the data logging apparatus 102 is frequently used for testing water and wastewater pumps.

The data logging apparatus 102 may utilize various connections for different pumps, and these connections assist in retrieving information about the performance of the pump 104. For example, the data logging apparatus 102 may be connected to a control panel 108 using voltage probes 120 and current transducers 210, and in some embodiments, three voltage probes 120 and four current transducers 210 are provided. The data logging apparatus 102 may also be connected to other onsite instrumentation 110, the data logging apparatus 102 may also be connected to one or more sensors 114 and a flow meter 116 that may be disposed at a discharge pipe 112 of the pump 104, and data logging apparatus 102 may also be connected to a level transducer 118 to measure the level of fluid in the wet well 106. The data logging apparatus 102 may also form a connection with one or more wireless sensors 170.

In some embodiments, the data logging apparatus 102 may operate using various electric service types, including but not limited to Single Phase-Two Wire, Single Phase-Three Wire, Three Phase-Four Wire (WYE), Three Phase-Three Wire (DELTA), and Corner Grounded Delta electrical services. However, some embodiments of the data logging apparatus 102 only operate using one or more of these service types. Additional service types may also be used in other embodiments.

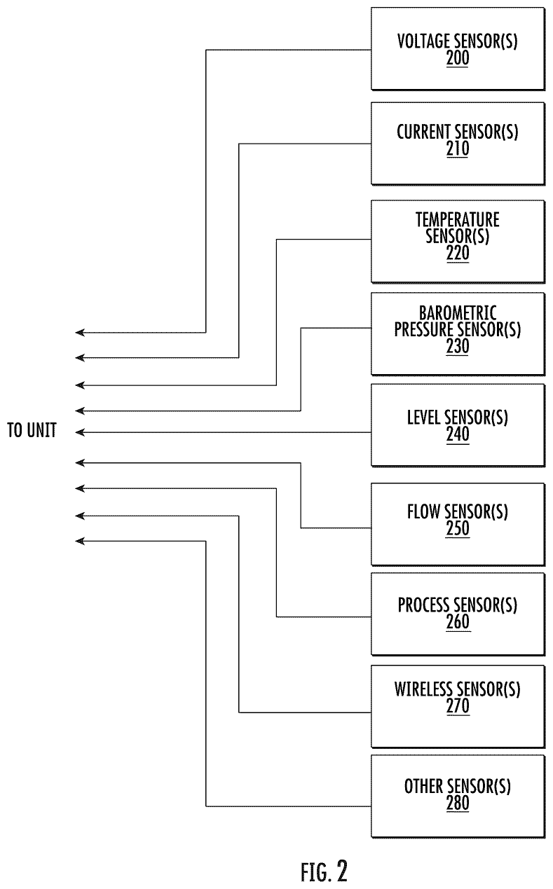

FIG. 2 is a schematic diagram of various sensors that may be utilized. A preferred embodiment of the data logging apparatus 102 possesses eight (8) inputs for sensors operating at 4-20 mA. However, other embodiments may possess one or more inputs operating at various current levels. Embodiments of the data logging apparatus 102 may utilize one or more voltage sensors 200, current sensors 210, temperature sensors 220, barometric pressure sensor 230, level sensors 240, and/or flow sensors 250. In addition, the data logging apparatus 102 may utilize one or more process sensors 260, wireless sensors 270, and/or additional sensors 280. Additional sensors 280 may, for example, include tachometer sensors or rotational speed sensors. The sensors illustrated in FIG. 2 will be discussed in greater detail below.

Certain embodiments may comprise voltage sensors 200, which may measure RMS voltage. These voltage sensors 200 may comprise voltage sensor leads, and they may also be Voltmeter probe extension cables with male banana jacks on one end and female banana jacks on the other. While a preferred embodiment possesses male and female banana jacks, other connection mechanisms may be utilized. Voltage sensors may also comprise magnetic tip leads, which are voltmeter probe extension cables with male banana jacks on one end and magnetic tips on the other. The components that make up the voltage sensor leads and the magnetic tip leads may be rated for a minimum of 600 VAC. Voltage sensors may also comprise one or more clips such as alligator clips, but others may be used.

Some embodiments may comprise one or more current sensors 210. The current sensor(s) 210 may comprise a current transducer. Current sensor(s) 210 may also comprise a single 6-conductor cable, and this cable may comprise four inductive current clamps that may be wired into the cable. The cable may terminate with a 6-pin XLR connector on one end of the cable, but other connectors with a different number of pins may also be used. For example, an 8-pin connector may be used in other embodiments, and this connector may possess a different design. The current sensor(s) 210 may also comprise current clamps that will output a millivolt signal proportional to the current. In a preferred embodiment, the current sensor 210 may possess a measurement range of 0-400 amps, but this measurement range may vary in other embodiments. In a preferred embodiment, a Steren Model 602-285 or equivalent is used, however, other current sensors may also be utilized. The data logging apparatus 102 may take measurements from the current and voltage sensors using true RMS with high-speed digital signal processing.

Other various sensors may be used such as temperature sensor(s) 220, barometric pressure sensor(s) 230, level sensor(s) 240, and flow sensor(s) 250. Temperature sensors 220 may take the form of a thermistor. Barometric pressure sensors 230 may take the form of a 0-200 PSI pressure transducer or a +/−30 PSI pressure transducer. The level sensor 240 may take the form of an ultrasonic level transducer. However, other temperature sensors, pressure sensors, level sensors, and models for those sensors may be utilized. Further, the device can accept input from any 4-20 mA or 0-10 Vdc enabled device.

Process sensor(s) 260 are general purpose sensors that may be added as needed to complete a pump evaluation. Various process sensors may be utilized, including a vibration sensor, a tachometer, etc. An efector 800 Model VTV122 vibration sensor may be used as a process sensor 260 in one embodiment, but a Grainger 35T442 vibration sensor with a 35T475 cordset or other vibration sensors may be used in other embodiments. A set of alligator clips comprising 18″ long cables may also be utilized to allow other sensors to be used.

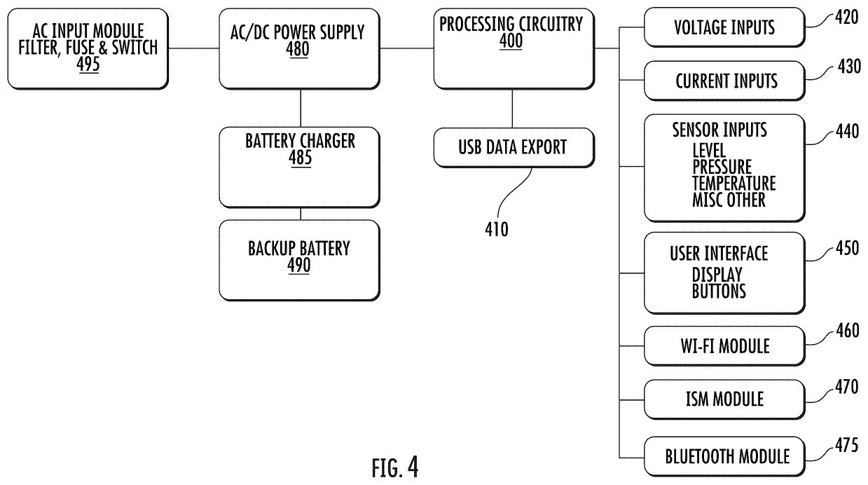

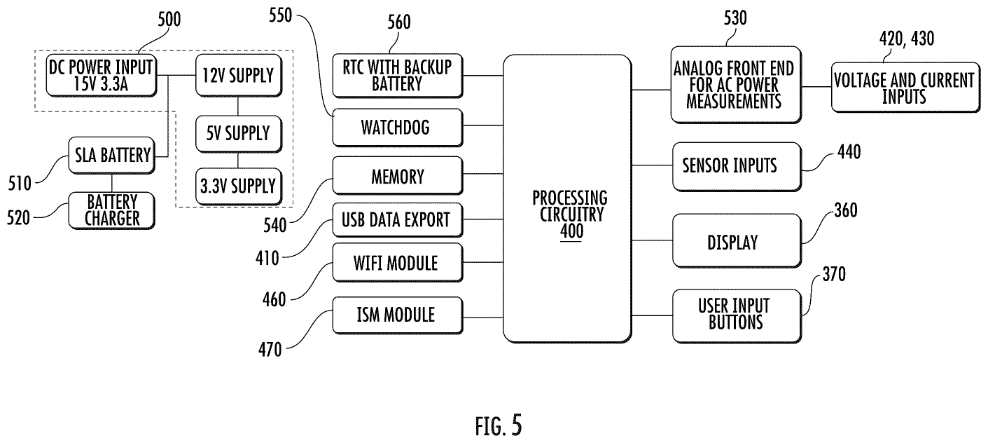

Additionally, in an embodiment, the data logging apparatus 102 may permit the use of one or more wireless sensors 270. The data logging apparatus 102 may comprise an ISM module 470 (see FIGS. 4-5), and this ISM module 470 may comprise a wireless transmitter with an ISM band radio operating at 2.45 GHz and an antenna. This wireless transmitter will enable communication to one or more wireless sensors 270 operating with a 4-20 mA or a 0-10 V input. In an embodiment, the data logging apparatus 102 may connect to six wireless sensors 270 simultaneously, but the data logging apparatus 102 may form connections with another number of wireless sensors in other embodiments. In an embodiment, at least two channels of data may be communicated from a wireless sensor through radio communication, but other embodiments may permit radio communication through only one channel of data from the wireless sensor. The wireless transmitter may be retained within a plastic water-resistant housing, and it may also comprise a rechargeable battery capable of providing an 8-hour run time.

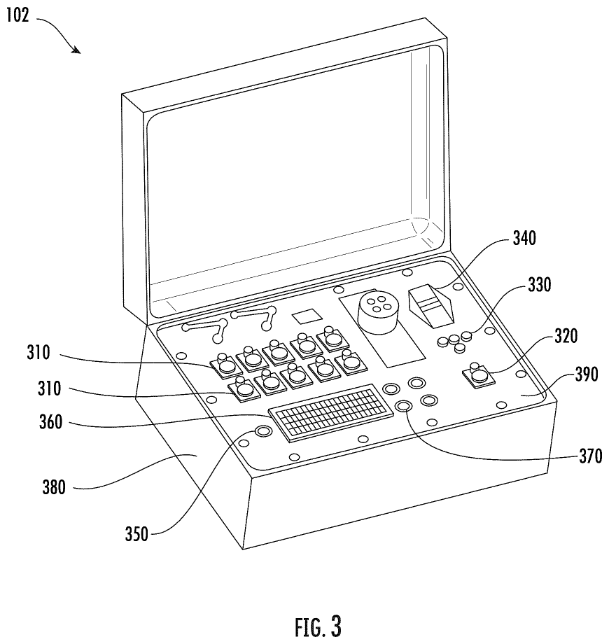

The data logging apparatus 102 may record data from sensors at specified time periods. In an embodiment, users may adjust the time period from a minimum interval of one second to a maximum interval of 600 seconds. However, in other embodiments, time periods outside this range may be selected by a user. The user may adjust the time period in various ways, including, for example, via a tablet. However, the time period may also be adjusted using the user interface buttons 370 (see FIG. 3) in other embodiments.

FIG. 3 is a perspective view of an embodiment of the data logging apparatus 102. As shown within FIG. 3, embodiments may possess one or more analog connectors 310, one or more current transducer connectors 320, and one or more voltage probes 330. Additionally, embodiments may include an input power jack 340 and a power switch 350. The embodiments may also possess a display 360 and one or more user interface buttons 370.

FIG. 3 shows an embodiment comprising ten analog connectors 310, but other embodiments may be utilized that comprise one or more of these analog connectors 310. For example, other embodiments have six 4-20 mA analog connectors 310 and two 0-10 V analog connectors. Alternatively, in some embodiments, analog connectors 310 may not be included. The analog connectors 310 may be metal housing 6-pin XLR audio connectors. In one embodiment, the plug for the analog connector(s) 310 may comprise a Neutrik NC3MXX Male XLR 6-pin Connector, a Nickel Shell, Silver Contacts and a Neutrik NC3FD-L-B-1 6-Pole Female Receptacle with Black Metal Housing and Gold Contacts. However, other analog connectors may be used. Additionally, connectors having other numbers of pins may also be used. The analog connectors may be 4-20 mA inputs.

The embodiment shown in FIG. 3 also includes a current transducer connector 320. While this embodiment possesses only one current transducer connector 320, other embodiments may comprise additional current transducer connectors. Alternatively, in some embodiments, the current transducer connector 320 may not be included. The current transducer connector 320 may comprise a Neutrik Speakon NL8FC connector, but other current transducer connectors may also be used.

FIG. 3 also shows an embodiment where the data logging apparatus 102 possesses four voltage probes 330. While this embodiment possesses four voltage probes 330, other embodiments may comprise a different number of voltage probes 330. Alternatively, in some embodiments, voltage probes 330 may not be included. Voltage probes 330 may comprise a standard 1 kV rated multimeter banana type plugs and jacks with strain relief. However, the voltage probes 330 may comprise other types of plugs and jacks. Three of the voltage probes 330 may be red in color while a fourth voltage probe may be black in color. The inclusion of these voltage probes 330 allows users to quickly check the voltage of a device. By including this feature on the external interface panel 390, users may save time in authenticating the voltage measurements or other measurements produced by the data logging apparatus 102. Additionally, the inclusion of this feature on the external interface panel 390 allows for a user to safely connect the voltage probes 330 while minimizing any harm to the data logging apparatus 102.

The data logging apparatus 102 may comprise an auxiliary fast blow cartridge fuse that is removable without opening the external interface panel 390. This makes the data logging apparatus 102 safer for users and minimizes the risk that users will cause harm to the data logging apparatus 102 and/or a pump.

The data logging apparatus 102 may also comprise an input power jack 340. This input power jack 340 may comprise a three (3) pronged plug with a fuse and line filtering, and it may take the form of an IEC320 C13 power jack. However, other input power jacks may also be utilized. The input power jack 330 may be equipped with a surge suppressor. In a preferred embodiment, the input power jack 330 may provide input power operating at 120 VAC and 60 Hz. However, input power may be provided in numerous ways, and input power may be provided at other voltages and/or frequencies in other embodiments.

As shown in FIG. 3, the depicted embodiment possesses a display 360 and four user interface buttons 370. While four user interface buttons 370 are included in the depicted embodiment, one or more user interface buttons may be included in other embodiments. The display 360 presents information to users in a variety of formats, and a user interface that may be presented on the display 360 will be described in greater detail below. The user interface buttons 370 enable the user to interact with a user interface on the display 360 to accomplish a variety of tasks such as selecting the appropriate screen to view, inputting data or commands into the data logging apparatus 102, etc. User interface buttons 370 may be illuminated by LED lights so that the buttons appear in different colors. As shown in FIG. 5, the display 360 and user interface buttons 370 (which may also be referred to as user input buttons) may be connected to processing circuitry 400 in a data logging apparatus 102.

As depicted in FIG. 3, the data logging apparatus 102 may include a case 380 to protect the inner contents of the data logging apparatus 102. In an example embodiment, this case is a Pelican iM 2200 case. Such a case is durable and suitable for outdoor use, and the case may possess handles so that the data logging apparatus 102 is easily transportable. However, other cases may also be used. In a preferred embodiment, the case 380 may be at least 15″×10.50″×6.00″ in size, but other case sizes may be used in other embodiments. The data logging apparatus 102 may be configured to be carried by only one person. For example, the data logging apparatus 102 may weigh less than 50 pounds in some embodiments so that an ordinary person may be able to carry the data logging apparatus 102. In other embodiments, the data logging apparatus may weigh less than 40 pounds, less than 30 pounds, less than 20 pounds, or even less than 10 pounds.

As discussed above, the data logging apparatus 102 may include an interface panel 390. This interface panel 390 may be constructed of polypropylene or ABS plastic, but other materials may also be used. The interface panel 390 may include labels for some or all of the ports, buttons, and other features of the data logging apparatus 102 depicted in FIG. 3, and these labels may assist the user and ensure that the user is operating the data logging apparatus 102 correctly. The interface panel 390 may be removable from the case 380 in some embodiments.

The data logging apparatus 102 may also include an interior lower panel that may be installed inside the data logging apparatus 102 and beneath the interface panel 390. This interior lower panel may be constructed of 3/16″ ABS plastic, polypropylene, or aluminum, and the interior lower panel may be rest on plastic standoffs that are installed on the bottom of the interior of the case 380. The interior lower panel may also comprise various standoffs that may be used to secure circuit boards and other components.

FIG. 4 is a schematic diagram of the system architecture within an embodiment. FIG. 5 is a schematic diagram showing a system control PCB block diagram within an embodiment. The data logging apparatus 102 may comprise a printed control board (PCB) with other components implemented into the PCB. This PCB may perform a variety of functions. These functions include but are not limited to collecting data from the analog inputs, configuring and collecting data from sensor inputs, collecting data from wireless sensor modules, running the user interface, saving data to a USB drive, and sending data to a tablet. The PCB may receive DC power from an external 15V supply. This external supply may also provide power at 3.3 A, but other external power supplies may be used that operate at a different voltage or current. On-board power supplies 500 (see FIG. 5) may generate the voltages necessary for proper operation of the data logging apparatus 102 (12V, 5V, 3.3V, 2.5V, etc.). Additionally, a 12V Sealed Lead Acid (SLA) battery 510 (see FIG. 5) may provide backup power, allowing the unit to operate for at least 4 hours without AC input power. In a preferred embodiment, this SLA battery 510 will be connected to a battery charger 520 to allow the SLA battery 510 to charge whenever AC power is applied to the data logging apparatus 102, and the SLA battery 510 may charge to full capacity within 4 hours.

Now referring to FIG. 4, the data logging apparatus 102 may also comprise processing circuitry 400, and this processing circuitry 400 may be provided in the form of a microcontroller implemented into the PCB. The processing circuitry 400 may be from the Atmel ARM Cotrex-M7 family. The processing circuitry 400 may include an Atmel ATSAME70Q21B-ANT microcontroller, but other microcontrollers, microprocessors, processors, controllers, and similar computing devices may be utilized. In an embodiment, the processing circuitry 400 operates at 300 MHz, which may provide the necessary bandwidth to handle the analog input, calculations, user interface, and data export features. However, the processing circuitry 400 may operate at other frequencies in other embodiments. In an embodiment, the processing circuitry 400 comprises an internal 12 channel, 12-bit analog to digital converter that may be used to sample the sensor inputs, but different converters may be utilized. The processing circuitry 400 may also host a web page supporting remote data access so that other devices may access the data. Additionally, the processing circuitry 400 may provide USB Host functions to permit data to be saved to a local USB drive. The processing circuitry 400 may be connected to a USB data export 410 to permit users to upload or download data via a removable USB device. While one embodiment possesses a USB Type A port, other USB ports may be utilized.

As shown in FIGS. 4 and 5 and discussed above with respect to FIG. 2, the data logging apparatus 102 may comprise or otherwise permit the connection of various inputs. These figures show that voltage inputs 420 and current inputs 430 may be used, and that sensor inputs 440 such as level, pressure, temperature, and other sensors may be used. As shown in FIG. 5 specifically, the data logging apparatus 102 may also include a dedicated analog front-end integrated circuit 530 within the PCB. AC voltage and current values may be sent to the integrated circuit 530. This integrated circuit 530 may provide specialized features common to power measurement, including but not limited to sampling, decimation, filtering, and calculations providing voltage, current, and power factor. This data may then be sent from the integrated circuit 530 to the processing circuitry 400 via a serial bus. Once this data is sent to the processing circuitry 400, the data may be used to perform calculations, may be presented to users, may be graphically displayed, etc.

Referring back to FIG. 4, the data logging apparatus 102 also comprises a user interface 450, which is described in greater detail below. FIGS. 4 and 5 show that the data logging apparatus 102 may comprise a Wi-Fi module 460, but a wireless LAN (WLAN) module may also be used to establish a wireless connection with nearby devices. The Wi-Fi module 460 may provide the necessary functions to create a wireless access point, and the Wi-Fi module 460 may support IEEE 802.11 b/g/n standards. The use of such a Wi-Fi module 460 may enable most tablets and phones to be able to access data from the data logging apparatus 102. Other Wi-Fi modules may also be used.

The data logging apparatus 102 may comprise a Bluetooth module 475 to allow for the connection with nearby devices. This module will also connection with devices within a certain range. To accomplish this, the Bluetooth module 475 may comprise an internal antenna. This antenna may possess a range of up to 100 feet in some embodiments, but various ranges may be utilized. The antenna may connect to various devices, including, for example, Android devices. A Bluetooth connection with these devices enables data to be viewed or stored on other devices. This Bluetooth module 475 may be included alongside a Wi-Fi module 460, or the Bluetooth module 475 may be used instead of the Wi-Fi module 460. As referenced above in the discussion of FIG. 2, the data logging apparatus 102 may also comprise an ISM module 470.

Each of the inputs 420, 430, 440, the user interface 450, and the modules 460, 470 discussed above may communicate with the processing circuitry 400 and may also be connected to the PCB.

As shown in FIG. 4, various components may provide power to the data logging apparatus 102. Such components may include an AC/DC power supply 480, a battery charger 485, a backup battery 490, and an AC input module, filter, fuse, and switch 495. However, instead of or in addition to using these components, other components may provide power to the data logging apparatus 102.

As shown in the FIG. 5 embodiment, the data logging apparatus 102 may include other components such as local memory 540, a watchdog timer 550, and a Real Time Clock (“RTC”) with Backup Battery 560. Each of these components may be connected to the processing circuitry 400. This local memory 540 may take the form of an electrically erasable programmable read-only memory (EEPROM) or a single micro SD card with up to 64 GB capacity. However, in other embodiments, memory may be stored in other ways. A watchdog timer 550 may also be included to help detect and recover from any malfunctions. The RTC 560 may provide data regarding the current time to the processing circuitry 400.

Some embodiments may also comprise specialized dedicated processing circuitry for measuring frequency and harmonics. This processing circuitry may permit users to evaluate critical information such as the electrical frequency, phase, phase shift values, etc, and the use of dedicated processing circuitry may permit more frequent and more accurate measurements for frequency and harmonics.

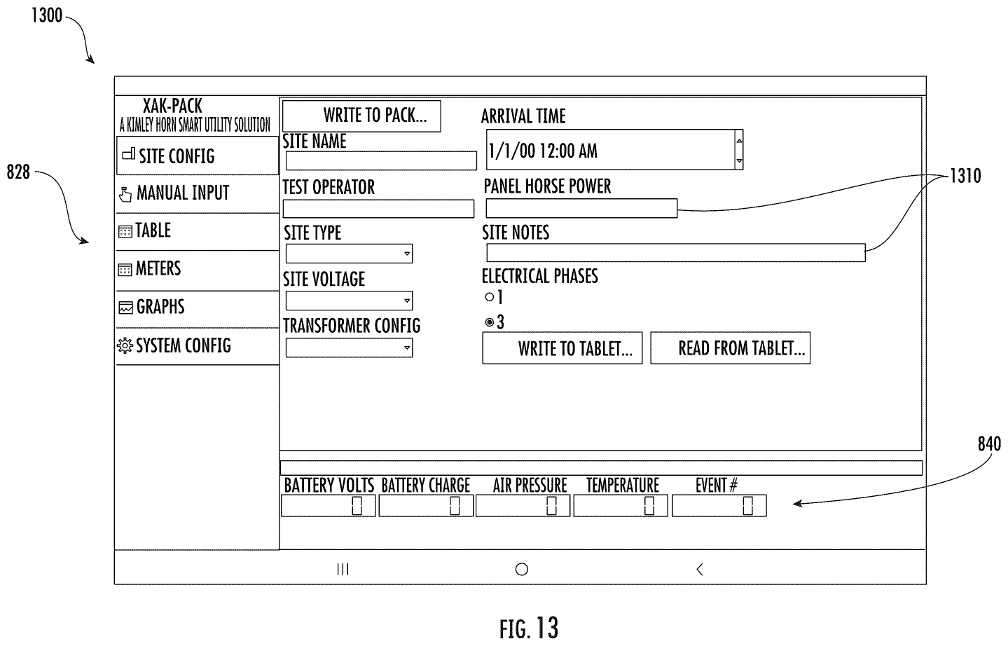

In some embodiments, users may move between various screens. For example, a home screen may be provided, and users may move from the home screen to other screens. The other screens may include setup screens, calculations screens, results screens, and data collection views. Where a home screen is used, the home screen may comprise at least two file options. First, the home screen may comprise an “Open File” option. This option will permit a user to select the file to open so that that additional logging, manually input values, calculations, and results can be viewed and/or modified. The home screen may also comprise a “New File” option. This “New File” option may permit the creation of a new file, enabling a user to input information regarding this new file. Upon selection of the “New File” option, a user may be directed to a site configuration view 1300 (see FIG. 13), and the user may be permitted to input information. This information may include a file name and site information. Site information may comprise various types of information. This information may include the name of the site being tested, the name of the person or people who are conducting the testing, the type of pump station being evaluated, the voltage of the site, the number of electrical phases at the site (e.g. one phase versus three phases), the type of voltage configuration at the site, arrival time, departure time, and panel horse power. However, other information may be included instead of or in addition to the site information listed above. Fields 1310 and/or drop-down menus may be utilized to obtain this site information.

The “New File” option at the home screen may also allow users to select various configuration options, which may include, for example, configurations for the wiring of the data logging apparatus 102 and configurations for the voltage level of the data logging apparatus 102. The “New File” option may also possess navigation links for navigating to other screens. The “New File” option may also allow users to select a start button that will activate the logging process, and users may then select an end log button that will terminate the logging process. In some embodiments, a user's selection of the start button will result in the presentation of a confirmation screen. This confirmation screen may ask for confirmation as to whether the user wishes to activate the start button. The user may confirm and activate the logging process, or the user may cancel the activation. However, in some embodiments, no confirmation screen is utilized. A confirmation screen may be utilized in a similar fashion upon a user's selection of the end log button.

In other embodiments, no home screen is provided, and no “New File” option or “Open File” option are available. Instead the data logging apparatus may start a new file whenever the data logging apparatus is started. Alternatively, the data logging apparatus may start a new file whenever a screen is selected. This screen may, for example, be the site configuration screen or the system configuration screen.

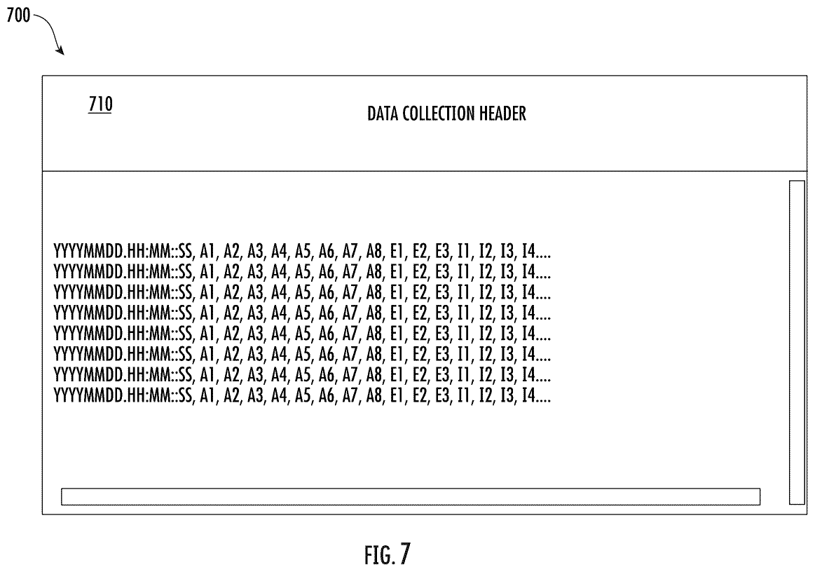

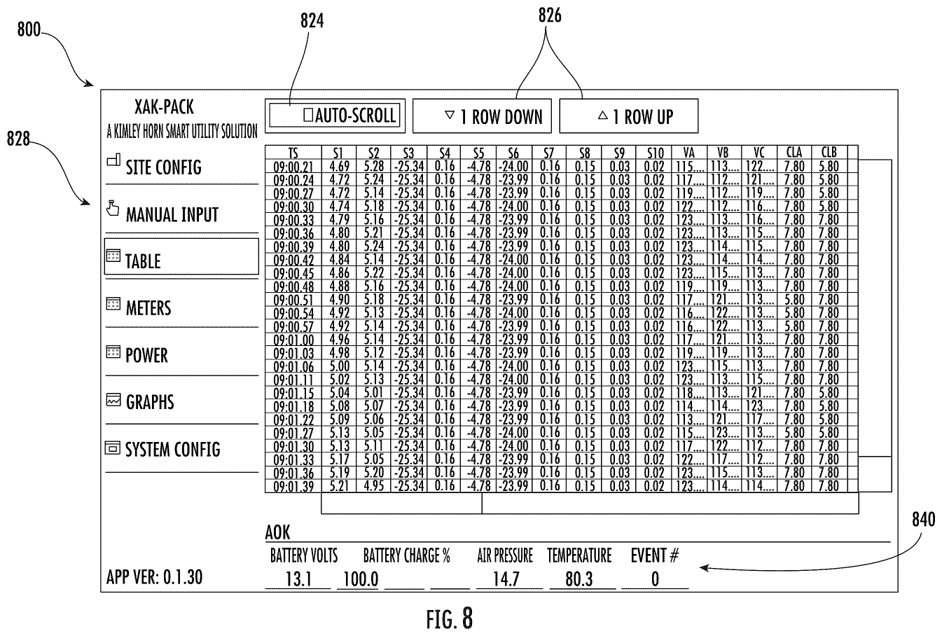

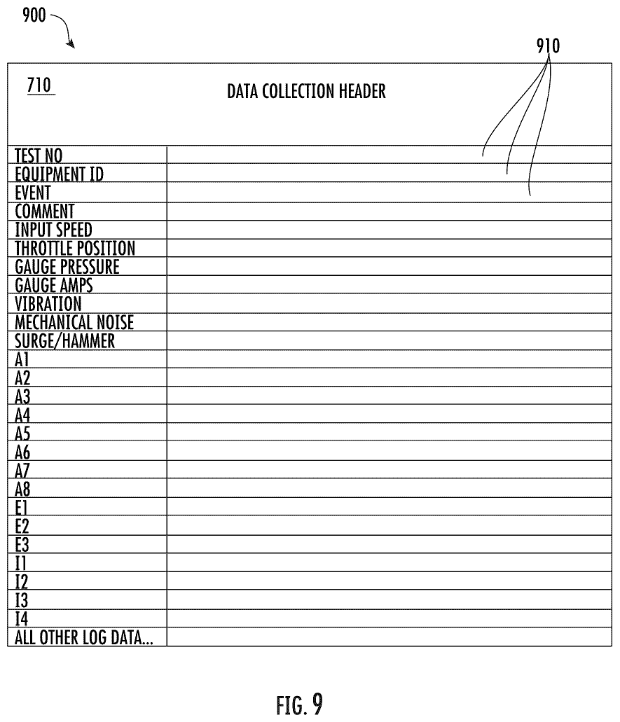

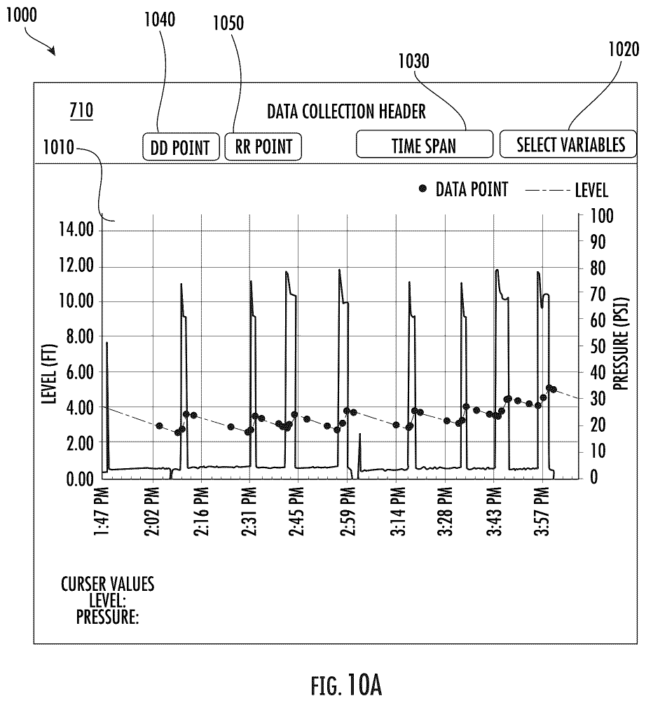

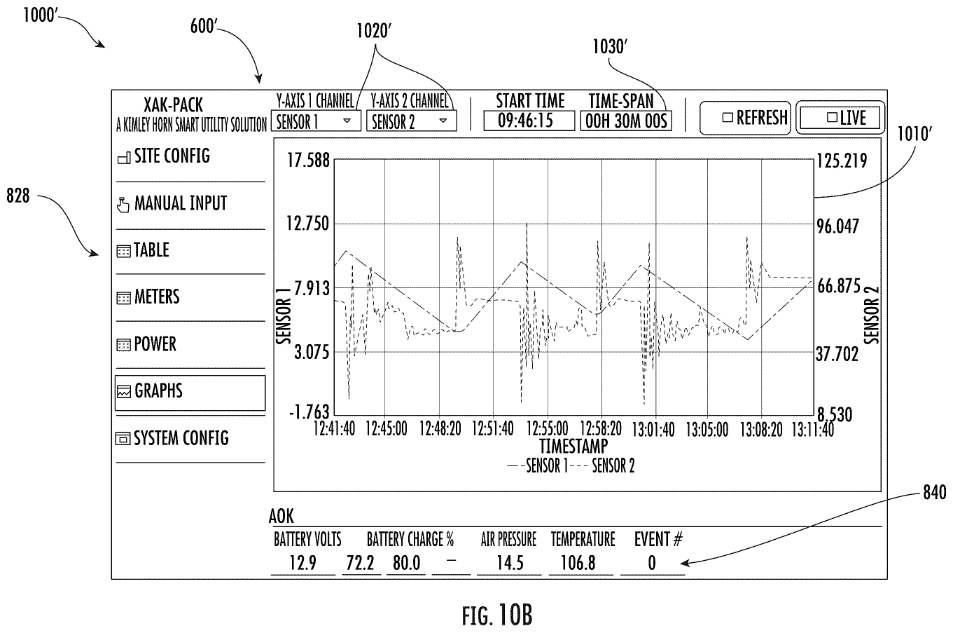

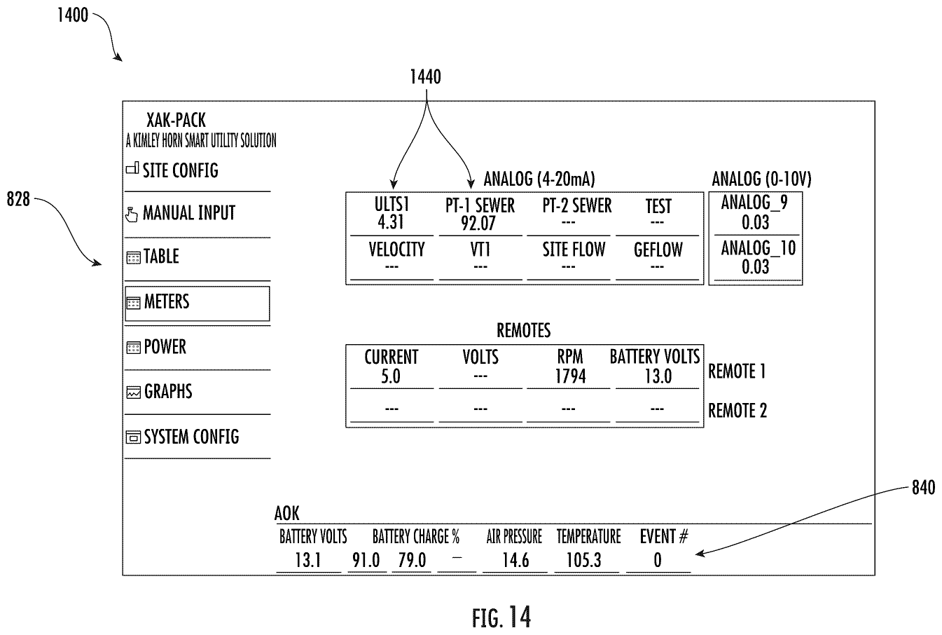

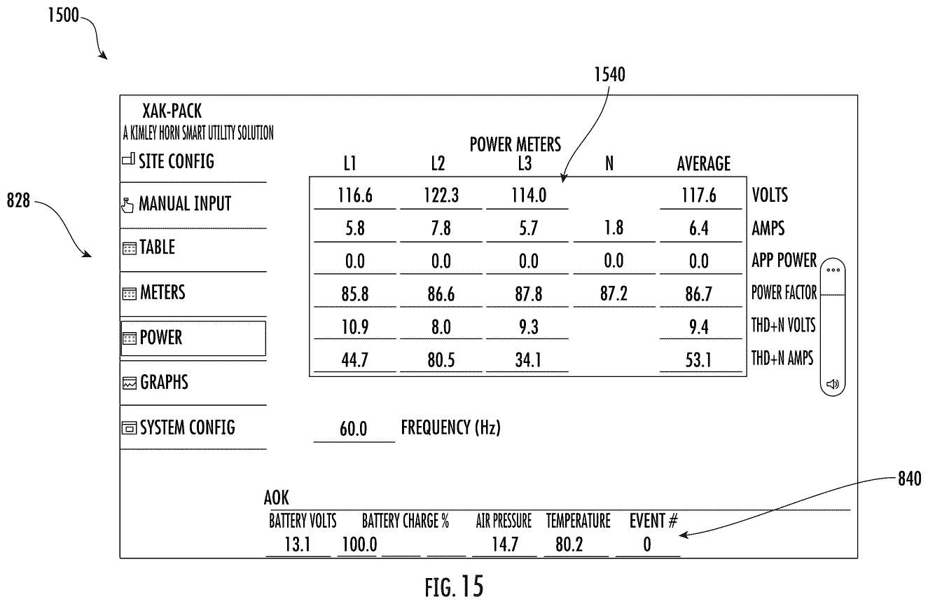

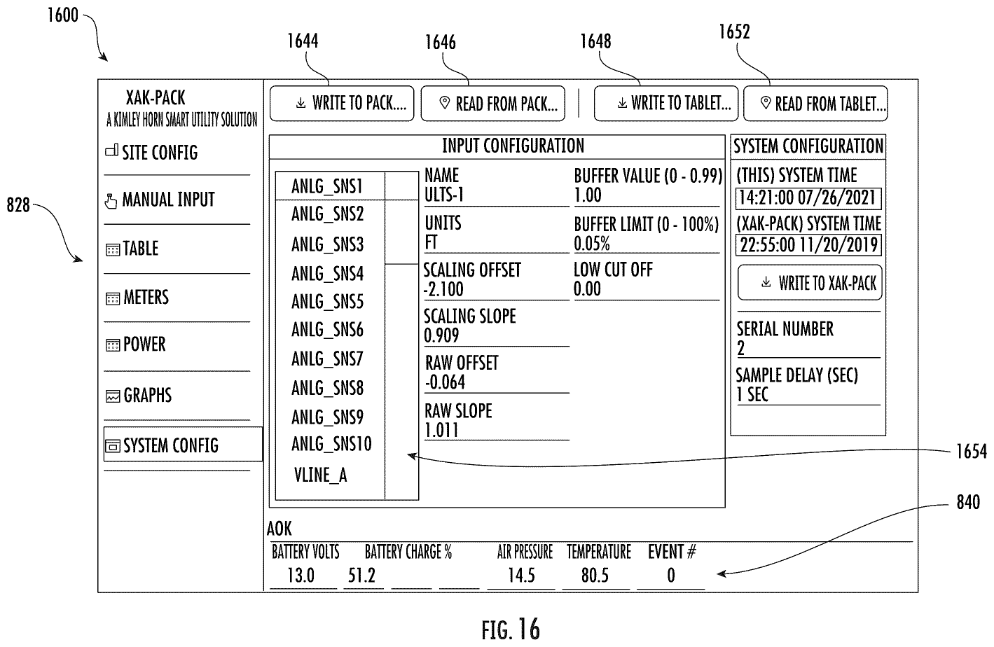

In some embodiments, a menu area 828 (see FIG. 8) may be provided instead of or in addition to the home screen. The menu area 828 (see FIG. 8) may permit a user to select the screen to be presented. For example, the menu area 828 may permit a user to select a scrolling data view 700, 800 (see FIGS. 7 and 8) (labelled in the menu area as “Table”), a manual input view 900 (see FIG. 9), a site configuration view 1300 (see FIG. 13), a meter data view 1400 (see FIG. 14), a power meter data view 1500 (see FIG. 15), a graphical presentation view 1000′ (see FIG. 10B), or a system configuration view 1600 (see FIG. 16). Other setup screens, calculations screens, and results screens may be used. Users may also view popup window(s) to manually input information. These screens will be discussed in greater detail below.

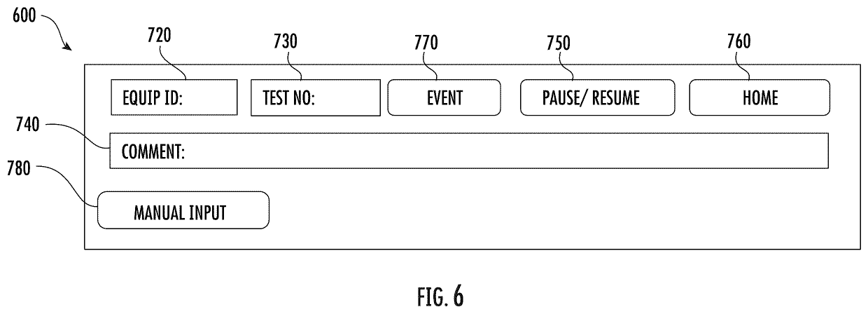

FIG. 6 is a view of a data collection header 600 that may be included within one or more data collection screens 700, 800, 900, 1000. The data collection header 600 permits users to input information into the data logging apparatus 102. As shown in FIGS. 8-10, the data collection header 600 may be implemented at the data collection header area 710 in data collection screens 700, 800, 900, 1000. Referring back to FIG. 6, users may input information about the pump being tested, which may be referred to herein as an equipment ID. This equipment ID may provide the name, identifying number, or another identifier of the pump. This equipment ID may be input into field 720. A test number may be input into field 730, and this may be used to input the test run at a given site if multiple tests must be performed on a single device. Comments may be input into field 740. Fields 720, 730, and 740 may take the form of a text box, drop down menu, or some other input field.

Data collection header 600 may also comprise one or more buttons that the user may select. The data collection header 600 may comprise a pause/resume button 750 that enables users to pause or resume the recording of data. While FIG. 6 shows a single pause/resume button 750, a separate pause button and resume button may be used. The data collection header 600 may also comprise a home button 760, which will permit users to return to a home screen or another screen. While FIG. 6 depicts a data collection header 600 with only a home button 760, other embodiments may utilize a drop-down menu, multiple buttons, or some other input field that allows a user to select and move to another screen (e.g. the setup screen). The data collection header 600 may also comprise an event button 770. Selection of the event button 770 will increment the event where users can record or bookmark the data at a specific point in time. In some embodiments, selection of the event button 770 will cause a popup window to appear, and this window may set the time that the event button 770 was clicked as the default time for the event. The user may then adjust the time of the event, provide a name of the event, and provide a description of the event. Additionally, the popup window may include options for the user to save or cancel the description of the event.

Users may also select a manual input button 780. Selection of this manual input button 780 may open a popup window that will enable users to insert information into various manual input fields. In some embodiments, the popup window may take the form of tabular view 1200, which is depicted in FIG. 9 and described in greater detail below.

Upon a user exiting a data collection screen, various information that is input into the data collection header 600 may be saved. Thus, the saved information may be preserved so that it may be auto-populated upon a user's return to a data collection screen. However, in some embodiments, users have the option to disable this feature.

FIG. 7 is a scrolling data view 700 that may be presented to users on a display 360 or on the display of a tablet. This view may present scrolling data consisting of continuously scrolling comma separated values. In the embodiment shown in FIG. 7, each line of scrolling data comprises (1) the date and time of the data entry, (2) data from analog inputs (A1-A8), (3) data from electrical inputs (E1-E3), and (4) other input data (I1-I4). Additionally, the electrical input phase shift values may also be displayed (e.g. Sᵥₐ . . . Sᵥₙ, Sᵢₐ . . . Sᵢₙ). In some embodiments, the scrolling data will present up to 6 digits and one decimal place for each measurement. However, the order and content within each line of scrolling data may vary. While FIG. 7 illustrates an example where only eight rows of data are being displayed, nine or more rows may be displayed in preferred embodiments. However, other embodiments may display fewer rows of data. The scrolling data may be presented so that the data will automatically scroll where newer data replaces older data automatically over time, but, in some embodiments, users may enable or disable the automatic scrolling depending on their preference. The scrolling data view 700 may comprise scroll bars to enable users to view desired data. The scrolling data view 700 may also be altered to change the display of information, including changing the background, text color, font, font color, and size.

FIG. 8 illustrates another example scrolling data view 800 that may be presented to users. A menu area 828 may be provided, and this menu area 828 may present several different views that the user may select from. A user may select one of the options in the menu area 828 to change the presented view. Various views are available for selection in the menu area 828 including a site configuration view 1300 (see FIG. 13), a manual input view 900 (see FIG. 9), a scrolling data view 700, 800 (labelled in the menu area as “Table”), a meter data view 1400 (see FIG. 14), a power meter data view 1500 (see FIG. 15), a graphical presentation view 1000′ (see FIG. 10B), and a system configuration view 1600 (see FIG. 16).

Data presented in the scrolling data view 800 illustrated in FIG. 8 may be configured to shift between a first mode where automatic scrolling occurs and a second mode where manual scrolling occurs. To switch to the first mode where automatic scrolling occurs, an auto-scroll button 824 may be selected. To switch to the second mode where manual scrolling occurs, manual scroll buttons 826 may be selected, and the user may use the manual scroll buttons 826 to view the desired information within the table.

Various types of data may be presented in the example scrolling data view 800. For example, various sensor values (S1, S2, . . . . S10), voltage values (VA, VB), and current values (CLA, CLB) are presented in the embodiment illustrated in FIG. 8. However, other types of data may also be presented. Fields 840 may also present information about other relevant parameters. In some embodiments, these fields 840 may be presented regardless of the view selected. For example, these fields 840 remain visible in the views presented in FIGS. 8, 10B, 13, 14, and 15. Fields 840 include information regarding the battery voltage, the battery charge percentage(s) for any batteries, air pressure, temperature, and an event number, but other information may also be presented or certain information may be omitted.

Data presented in FIGS. 7 and 8 may be provided with synchronized time stamp values as illustrated in FIGS. 7 and 8, and this data may be recorded in memory 540.

FIG. 9 is a manual input view 900 that may be presented to users on a display 360 or on a display of a tablet. This manual input view 900 may display data to in a tabular format. In a preferred embodiment, this manual input view 900 may display all of the most recent data. The manual input view 900 may comprise scroll bars to enable users to view desired data. The manual input view 900 may also be altered to change the display of information, including changing the background, text color, font, font color, and size. In one embodiment, users may select the manual input button (FIG. 6, 780) within the data collection header (FIG. 6, 600), and this will cause the manual input view to appear. Users may select one of the input fields 910 in the second column to insert data.

FIG. 10A is an embodiment of an example graphical view 1000 that may be presented to users on a display. As shown in FIG. 10A, the graphical view 1000 may include a graph 1010, and this graph may plot one or more variables over a period of time. In the graph 1010 show in FIG. 10A, the level and pressure are plotted over a period of time. However, other variables may be utilized on the x-axis and the y-axis. In the embodiment depicted in FIG. 10A, y-axis values are shown on the left and right sides of the graph 1010, but in other embodiments, two or more types of data values may be shown on one side of the graph 1010. In a preferred embodiment, users may click on the graph 1010 to select a given point so that the data at that point may be displayed. In this embodiment, the user may click on the graph 1010 to select a value on the x-axis, and the data logging apparatus 102 will then display the selected x-axis value as well as the values for variables plotted on the y-axis that correspond to the x-axis value. For example, in the embodiment depicted in FIG. 10A, users may select a point corresponding to the value for 2:16 P.M. and the graphical view 1000 may display the level and pressure values at that time. In one embodiment, the data logging apparatus 102 enables users to select the intervals between values on the x-axis and the y-axis. Thus, while the major intervals for the level shown in FIG. 10A are approximately 2 feet, the user may alter this interval.

As shown in FIG. 10A, the graphical view 1000 may include various buttons that a user may select. These buttons include a select variables button 1020, a time span button 1030, a DD point button 1040, and an RR point button 1050. However, other buttons, input fields, or text fields may also be included. While the buttons within FIG. 10A are shown as being part of the data collection header 600, these buttons may also be implemented at other portions of the graphical view 1000.

The select variables button 1020 allows users to select one or more variables to be displayed on the x-axis and y-axis of the graph. While the graph within FIG. 9 includes data for the level and pressure on the y-axis, a user may click on the select variables button 1020, and this may present a list of possible y-axis values that may be included. The user may then select or deselect variables to be included in the graph.

In embodiments where the x-axis displays time, the graphical display may possess a time span button 1030. Users may select the time span button 1030 so that the users may specify the time intervals to be used in the graph. For example, users may specify that data be displayed in various time intervals of 5, 10, 15, 30, 60, or 120 minutes. However, other intervals may be used. In other embodiments, a similar button may be included for other variables or the intervals may be adjusted by selecting the select variables button 1020.

The graphical display may comprise a DD point button 1040 and an RR Point button 1050. A user may select the DD point button 1040 to enable a user to record a draw down point, which is the outflow rate at a given point in time. The RR point button 1050 may be selected by a user to enable the user to record a rate of rise point, which is the inflow rate at a specific time.

FIG. 10B illustrates another example graphical view 1000′ that may be presented. As illustrated, a graph 1010′ may be presented that is similar to the graph 1010 of FIG. 10A. As illustrated, an alternative data collection header 600′ may be provided. This alternative data collection header 600′ allows for the selection of Y-axis variables using drop down menus 1020′. This also provides a time-span input field 1030′, allowing a timer to be set for operation of the data logging apparatus 102. This graphical view 1000′ may include various buttons that a user may select.

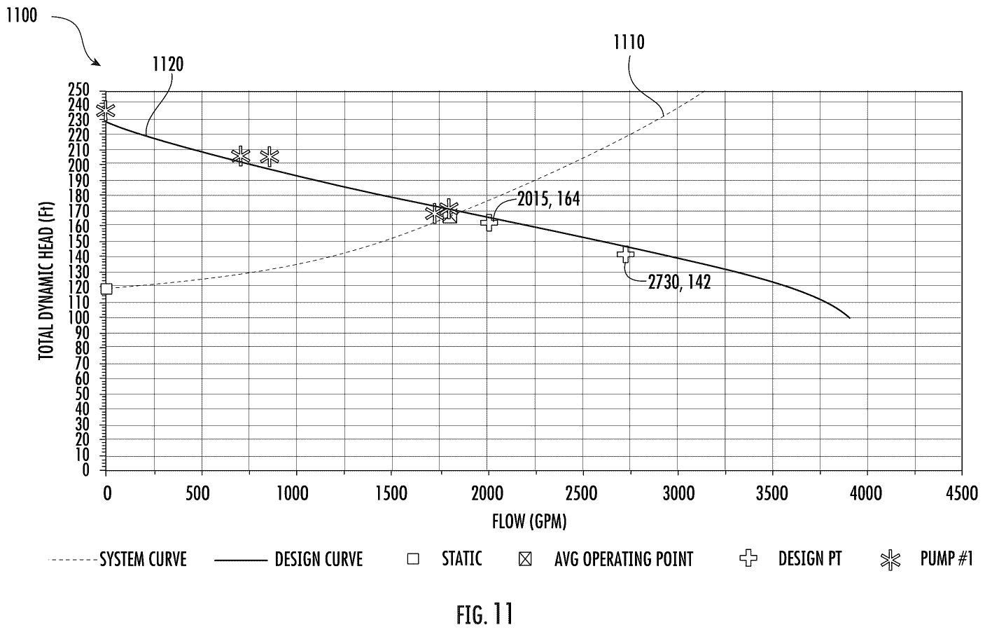

FIG. 11 is a view of the graphical results screen 1100 that may be presented to users. In the embodiment depicted in FIG. 11, a system curve 1110 and a design curve 1120 are plotted, with flow on the x-axis and total dynamic head plotted on the y-axis. By plotting the system curve 1110 and the design curve 1120, the users may determine the pump design point, which is the point where a pump operates at maximum efficiency. The graphical results screen 1100 may be presented on a display 360 (see FIG. 3) or presented at another location.

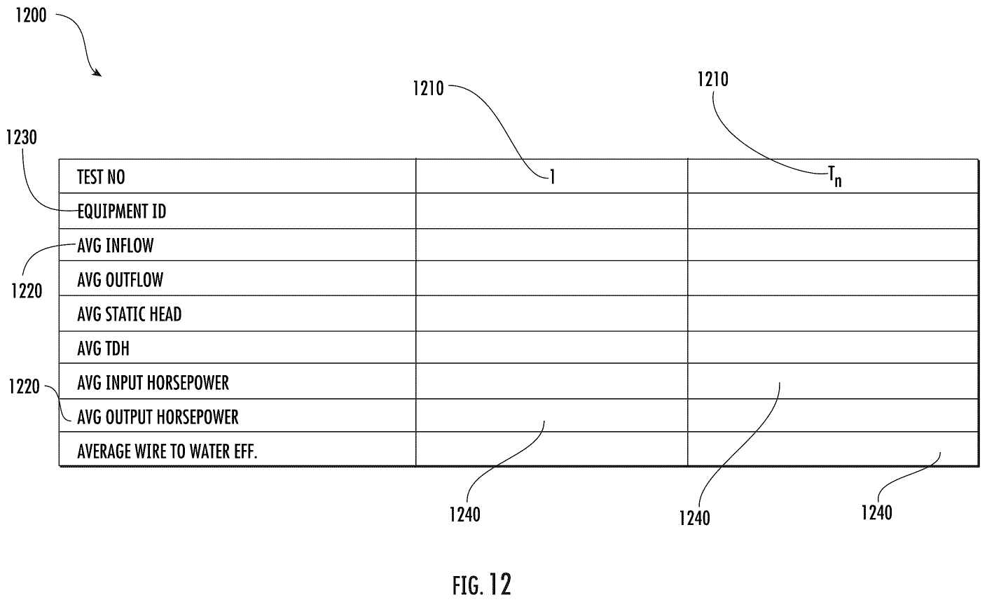

FIG. 12 is a view of the tabular results screen 1200 that may be presented to users on a display. This may present recorded data for each test that is conducted for various data. The tabular results screen 1200 provides the average results for each test for various types of data 1220. The tabular results screen 1200 may also list the equipment ID 1230 of the device that was being tested. The test number 1210 provided in first row of the tabular results screen 1200 may be generated based on user input. While FIG. 12 shows primarily shows the average results for each test, including the average inflow and average outflow, median, maximum, minimum, and other values may also be shown in fields 1240.

A calculations screen may also be provided. This screen allows users to provide additional input and also allows users to view the average calculations for each test run. Various calculations may be displayed on this screen. These calculations include the inflow rate, outflow rate, static head, total dynamic head, input horsepower, output horsepower, and wire to water efficiency. However, other calculations may also be displayed. Some calculations may be automatically presented, but some additional calculations may also be presented based on user input. This calculations screen may beneficially allow the user to visualize data and make calculations from that data. In some embodiments, equations may be saved within the memory 540 (see FIG. 5) in the data logging apparatus 102, users may select their desired calculation, the data logging apparatus 102 may then quickly select and utilize the appropriate equation to make the desired calculation based on the data. In some embodiments, users may enter their own equations manually.

FIG. 13 illustrates a view of a site configuration view 1300. This site configuration view 1300 provides multiple input fields 1310, and these input fields 1310 permit the user to input data about the site where the data logging apparatus 102 (see FIG. 3) is being used. By doing so, the data logging apparatus 102 may make more accurate calculations. Input fields 1310 may be provided for the name of the site, the test operator, the site type, the site voltage level, the transformer configuration, the arrival time of the user, the panel horsepower, and the number of electrical phases. An input field 1310 may also be provided to permit a user to include additional site notes. This may permit a user to input information explaining potential causes for irregular data. Once information is added into the input fields 1310 for a given site, the data logging apparatus 102 may be configured to auto populate certain fields on subsequent visits to the site.

FIGS. 14 and 15 illustrate a meter data view 1400 and a power meter data view 1500 respectively. These views may include data fields 1440, 1540 presenting data about the operation of a pump. The meter data view 1400 may present measurement data for each of the connected inputs. The data may include voltage, current, power, power factor, total harmonic distortion, total harmonic distortion plus noise (THD+N).

FIG. 16 illustrates a system configuration screen 1600. The system configuration screen 1600 allows the user to view and/or change the configuration of inputs. A selection area 1654 may present various inputs to the user, and the user may select a specific input to obtain further information. Inputs may be from analog connectors 310 (see FIG. 3), current transducer connectors 320 (see FIG. 3), and voltage probes 330 (see FIG. 3), but other inputs may be listed as well.

Various types of information may be viewed and/or changed in the system configuration screen 1600 for a given input. For example, the name and unit of measure may be altered. The scaling offset and scaling slope may be adjusted as well, with the scaling offset being the b-value in Y=mx+b and with the scaling slope being the m-value. Raw offset and raw slope values are also provided. These may be used to calibrate the system so that an increased accuracy is obtained. Other values may include buffer value, buffer limits, and a low cut off value.

The system configuration screen 1600 may also allow the user to view and/or change the system time, unit serial number, and sample delay. This system configuration screen 1600 includes various buttons. This may include a Write to Pack button 1644, a Read from Pack button 1646, a Write to Tablet button 1648, and a Read from Tablet button 1652. The Write to Pack button 1644 is configured to send data in user entry fields on the screen to be saved in memory on the data logging apparatus 102. The Write to Tablet button 1648 is configured to send data in user entry fields on the screen to be saved in memory on a connected tablet. In some embodiments, the Write to Pack button 1644 and the Write to Tablet button 1648 will save only data in the user entry fields on the presented screen, but these buttons 1644, 1648 may also save data that has been input on other screens that are not actively being presented. The Read from Pack button 1646 will load a configuration file saved on the data logging apparatus 102 (see FIG. 3), and the read from tablet button 1652 will load a configuration file saved on a connected tablet. In some embodiments, the buttons 1644, 1646, 1648, 1652 may be provided within the data collection header area 710 (see FIG. 9) regardless of the screen that is presented. However, in other embodiments, the buttons may only be presented for some of the views (e.g. views where a user is prompted to input data into input fields).

It will therefore be readily understood by those persons skilled in the art that the present invention is susceptible of broad utility and application. Many embodiments and adaptations of the present invention other than those herein described, as well as many variations, modifications and equivalent arrangements, will be apparent from or reasonably suggested by the present invention and the foregoing description thereof, without departing from the substance or scope of the present invention. Accordingly, while the present invention has been described herein in detail in relation to its preferred embodiment, it is to be understood that this disclosure is only illustrative and exemplary of the present invention and is made merely for purposes of providing a full and enabling disclosure of the invention. The foregoing disclosure is not intended or to be construed to limit the present invention or otherwise to exclude any such other embodiments, adaptations, variations, modifications and equivalent arrangements.

What is claimed is:

1. A pump performance data logging system, said pump performance data logging system comprising:
a pump;
a plurality of sensors configured to measure at least two different parameters regarding the operation or condition of the pump; and
a data logging apparatus having:
a plurality of sensors ports that are configured to receive the plurality of sensors;
processing circuitry;
memory; and
a case,
wherein the case is configured to encase the plurality of sensor ports, the memory, and the processing circuitry, and wherein the data logging apparatus weighs 50 pounds or less.

2. The pump performance data logging system of claim 1, further comprising a tablet having a display, wherein the data logging apparatus is configured to send information to the tablet for presentation on the display.

3. The pump performance data logging system of claim 2, wherein the display is configured to present at least one of an electrical frequency, an electrical phase, or an electrical phase shift value of the pump.

4. The pump performance data logging system of claim 1, wherein the data logging apparatus includes a dedicated processing circuitry for measuring at least one of an electrical frequency or electrical harmonics data.

5. The pump performance data logging system of claim 1, wherein the data logging apparatus is configured to receive an input from a user, wherein the processing circuitry is configured to adjust the operation of the data logging apparatus based on the received input.

6. The pump performance data logging system of claim 1, wherein the data logging apparatus is configured to receive an input from a user, wherein the processing circuitry is configured to calculate a performance metric based on the received input.

7. The pump performance data logging system of claim 2, wherein the display is configured to present the performance metric.

8. The pump performance data logging system of claim 1, wherein the pump is a water or a wastewater pump.

9. The pump performance data logging system of claim 1, wherein the system includes at least ten sensor ports, wherein the at least ten sensor ports are analog ports.

10. The pump performance data logging system of claim 1, wherein data for the plurality of sensors is recorded in the memory with synchronized time stamp values.

11. The pump performance data logging system of claim 2, wherein the processing circuitry is configured to create a graph based on data from the plurality of sensors, wherein the processing circuitry is configured to cause presentation of the graph on the display.

12. A pump performance data logging apparatus, said pump performance data logging apparatus comprising:
a plurality of sensors ports that are configured to receive a plurality of sensors, wherein the plurality of sensor ports are configured to receive sensor data for at least two different parameters regarding the operation or condition of a pump;
processing circuitry;
memory; and
a case,
wherein the case is configured to encase the plurality of sensor ports, the memory, and the processing circuitry, and wherein the pump performance data logging apparatus weighs 50 pounds or less.

13. The pump performance data logging apparatus of claim 12, wherein the pump performance data logging apparatus is configured to send information to a tablet for presentation on a display of the tablet.

14. The pump performance data logging apparatus of claim 13, wherein the pump performance data logging apparatus is configured to send at least one of an electrical frequency, an electrical phase, or an electrical phase shift value of the pump to the tablet for presentation on the display.

15. The pump performance data logging apparatus of claim 12, wherein the pump performance data logging apparatus includes a dedicated processing circuitry for measuring at least one of an electrical frequency or electrical harmonics data.

16. The pump performance data logging apparatus of claim 12, wherein the pump performance data logging apparatus is configured to receive an input from a user, wherein the processing circuitry is configured to adjust the operation of the pump performance data logging apparatus based on the received input.

17. The pump performance data logging apparatus of claim 13, wherein the processing circuitry is configured to receive an input from a user, wherein the processing circuitry is configured to calculate a performance metric based on the received input.

18. The pump performance data logging apparatus of claim 17, wherein the pump performance data logging apparatus is configured to send the performance metric to the tablet for presentation on the display.

19. The pump performance data logging apparatus of claim 12, wherein the pump performance data logging apparatus includes at least ten sensor ports, wherein the at least ten sensor ports are analog ports.

20. The pump performance data logging apparatus of claim 13, wherein the processing circuitry is configured to create a graph based on data from the plurality of sensors, wherein the processing circuitry is configured to cause presentation of the graph on the display.
